(19) United States
(12) Patent Application Publication
(10) Pub. No.: US 2016/0020052 A1
(43) Pub. Date: Jan. 21, 2016

(54) SELF-ALIGNING POWER CONNECTION SYSTEM WITH POSITIVE-LATCH CONNECTION

(71) Applicant: SCHNEIDER ELECTRIC USA, INC., Palatine, IL (US)

(72) Inventor: Jeffrey M. KAUFMAN, West Liberty, IA (US)

(73) Assignee: SCHNEIDER ELECTRIC USA, INC., Palatine, IL (US)

(21) Appl. No.: 14/773,790

(22) PCT Filed: Mar. 11, 2013
(86) PCT No.: PCT/US13/30160

§ 371 Date: Sep. 9, 2015

(51) Int. Cl. H01H 71/02; H01R 25/16

(52) U.S. Cl. CPC H01H 71/0207; H01R 25/162

(57) ABSTRACT

Switchgear assemblies, power connection systems, and cluster connectors are presented herein. Power connection systems for connecting circuit breakers to electrical bus bars are disclosed. A power connection system includes an electrically conductive cluster support for attaching to the circuit breaker. The cluster support has a pivot projecting from a base, and a contoured latch projecting from the pivot. The system also includes a power connector for coupling to the bus bar. The power connector includes opposing pairs of electrically conductive fingers that are pivotably attached to a cage. Proximal end portions of the fingers are configured to straddle the pivot of the cluster support. Spring members bias the proximal end portions toward one another. The proximal end portions of the fingers cooperatively define a channel for receiving the pivot, and further define a slot for receiving the contoured latch to thereby secure the power connector to the cluster support.

### TECHNICAL FIELD

The present disclosure relates generally to power distribution devices and systems and, more particularly, to connectors for electrically coupling circuit breakers to power bus bars or for making other electrical connections.

### BACKGROUND

Circuit breakers are most commonly used to protect electrical equipment from overload and short circuit events. Large circuit breakers that carry thousands of amps of current are oftentimes installed into metal-enclosed switchgear assemblies, which are also referred to as “switchboards.” Switchgear assemblies have large electrical conductors called bus bars (or “buss bars”) that transmit current from a power source, such as a power utility, through the circuit breakers, to loads that are protected by the circuit breaker. These large circuit breakers, which can weigh hundreds of pounds, are typically lifted into the switchgear and racked by mounting the circuit breakers into a drawout cradle. A manually controlled or remotely operated mechanism is typically utilized to crank the drawout cradle and rack the circuit breaker into the switchgear and complete an electrical circuit which is protected by the breaker.

On the backs of these large circuit breakers facing the rear interior of the switchgear cabinet are connection members, such as bus bars, with elongated cluster supports that have pivots which jut out. Onto these pivots are installed multiple “clusters,” which are electrical connectors that have opposing stacks of plate-like fingers. These fingers straddle the pivots and allow the clusters to adapt their positions to engage bus bar connectors, such as fixed stab terminals (“stabs”) or turnable joint mount (TJM) connectors, which are housed inside the switchgear cabinets, for example, for a blind rack-in connection. These fingers are biased by spring elements to stay on the pivots so that the cluster “snaps” onto the pivot. It is important that these clusters remain secured on the pivots because if they become loose or dislodged as the circuit breaker is being racked into the switchgear or during operation of the switchgear, a cross-phase connection or a short circuit from an electrical phase to ground can occur.

The switchgear assembly typically comprises a cabinet that houses a drawout circuit breaker cradle for receiving and supporting the circuit breaker. The drawout cradle simplifies mounting and dismounting of the circuit breaker from field serviceable connections, allowing for ease of installation, removal, and maintenance. At the distal end of the cabinet on the opposite side of the opening through which the circuit breaker is received is a breaker backmold, which is often made from a rigid thermoset material, such as a phenolic resin, and used as a mounting interface. For instance, the backmold attaches to the circuit breaker cradle and provides a mounting surface for current transformers, metering transformers, and the power connectors (e.g., stabs or TJMs). The power connectors are typically designed to engage the circuit breaker clusters, field serviceable connections, and current and metering transformers.

Heretofore, various prior art approaches have been proposed for securing clusters to the pivots of circuit breakers. For example, one current approach requires fastening the clusters to the pivots using a U-shaped retainer pin and a retainer clip. Another current approach requires securing a cage around each group of clusters to anchor them onto the pivots. These approaches for securing clusters to circuit breaker pivots undesirably require additional installation time and labor due to the need for installing additional parts and for preforming additional installation steps. Many prior art approaches offer little by way of design to prevent misalignment of the electrically conductive fingers when securing a cluster to a pivot or when mating a cluster with a stab terminal. Likewise, many prior art designs do little to prevent the clusters from being displaced and/or becoming dislodged during handling and racking of the circuit breaker. What is needed are solutions that firmly and reliably secure the clusters onto their pivots with minimal complexity and fewer parts thereby reducing labor and material costs.

### SUMMARY

Disclosed herein are power connection systems that include self-aligning features and positive-latching connectors that help to obviate one or more of the aforementioned deficiencies in the prior art. For example, a variety of different configurations for self-locking self-aligning cluster connectors and positive-latching cluster supports are presented herein. In an exemplary configuration, each cluster connector includes opposing stacks of electrically conductive fingers that are shaped and sized to straddle a complementary pivot of an electrically conductive support. The finger stacks are pivotably mounted inside a cage with a respective leaf spring pressing against each stack of fingers. The leaf springs cooperatively bias together the proximal ends of the finger stacks to thereby hold the cluster on the pivot.

The proximal ends of the finger stacks cooperatively define a channel within which is received a complementary pivot of the cluster support. Projecting from the pivot is a contoured latch, such as a T-shaped rail, for latching the pivot to a cluster assembly. The contoured latch may take on other functional shapes that can provide the desired positive-latching function, such as T-shaped, mushroom-shaped, or triangular-shaped projections and rails. Once received inside a slot cooperatively defined by the proximal ends of the cluster fingers, the contoured latch of the pivot and the biased fingers of the cluster together lock the cluster connector to the cluster support. In addition, a forward-facing surface of the contoured latch is provided with angled guide surfaces which cooperate with complementary guide surfaces of the finger stacks to automatically align the fingers when the cluster is being secured to the pivot. The pivot and contoured latch can also be shaped and sized to allow the cluster to rotate on the pivot, allowing for the cluster to realign itself when being pressed onto the stabs of a bus bar connector. Some of the disclosed embodiments eliminate all space between the cluster fingers; this design allows for the stacking of cluster fingers one directly on top of the other which increases the cross section of conductive material which, in turn, increases the current carrying capacity of the cluster assembly.

Many of the disclosed power connection systems can be factory installed as well as retrofit into existing switchgear assemblies, and include parts that are easily replaceable in the field. When properly installed, these systems can significantly reduce the risk of cluster assemblies falling off during the handling, installation and removal of a circuit breaker assembly. In some of the disclosed embodiments, the power connection system's design is optimized to increase functionality while also reducing cost through reduced part complexity and reduced part count. In addition, the self-alignment feature allows for installation with live current-carrying members. In some embodiments, springs on each side of a cluster assembly allow each of the electrically conductive fingers to independently adjust to irregularities on contact surface points of the pivot. In addition, these designs are more efficient to manufacture and install by eliminating the need for specialized tools for installation. For some configurations, the cluster fingers can be hand squeezed for installation and removal of cluster assemblies.

According to one aspect of the present disclosure, a power connection system is presented for electrically connecting a circuit breaker to an electrically conductive bus bar. The power connection system includes an electrically conductive cluster support that is configured to attach to the circuit breaker. The cluster support has a base, a pivot projecting from the base, and a contoured latch projecting from the pivot. The power connection system also includes an electrically conductive cluster connector that is configured to electrically couple to the bus bar. The cluster connector includes a cage and opposing pairs of electrically conductive fingers that are pivotably attached to the cage. Each finger has opposing proximal and distal end portions. The proximal end portions of the opposing pairs of fingers are configured to straddle the pivot of the cluster support. The cluster connector also includes first and second spring members that bias the proximal end portions of the opposing pairs of fingers toward one another. The proximal end portions of the fingers cooperatively define a channel that is configured to receive the pivot. The proximal end portions further define a slot that is configured to receive the contoured latch of the pivot to thereby secure the cluster connector to the cluster support.

According to other aspects of the present disclosure, a switchgear assembly is presented for electrically coupling a circuit breaker to an electrically conductive power bus bar. The switch gear assembly includes a housing that is configured to receive therein the circuit breaker, and a backmold mounted at a distal end of the housing. The switch gear assembly also includes an electrical power connector with a stab terminal projecting from a base. The base of the power connector is mounted to the backmold and configured to electrically connect to the bus bar. Also included is an electrically conductive cluster support that is configured to attach to the circuit breaker. The cluster support has a base, a pivot projecting from the base, and a contoured latch projecting from the pivot. The switch gear assembly further comprises an electrically conductive cluster connector including a cage, a cluster, and first and second spring members. The cluster includes opposing pairs of electrically conductive fingers that are pivotably attached to the cage. Each finger has opposing proximal and distal end portions, where the proximal end portions of the fingers are configured to straddle the pivot of the cluster support, and the distal end portions are configured to electrically mate with the stab terminal of the electrical power connector. The spring members bias the proximal end portions of the opposing pairs of fingers toward one another. The proximal end portions of the cluster fingers cooperatively define a channel that is configured to receive the pivot, and further define a slot that is configured to receive the contoured latch of the pivot to thereby secure the cluster connector to the cluster support.

According to additional aspects of this disclosure, a self-locking cluster connector is disclosed for connecting a circuit breaker to an electrically conductive bus bar. The bus bar includes an electrical power connector with a stab terminal, and the circuit breaker includes a cluster support with a pivot projecting from a base. The cluster connector includes a cage with first and second opposing stacks of electrically conductive asymmetric plates disposed inside of and pivotably attached to the cage. Each plate has opposing first and second end portions, where the first end portions are configured to receive and attach to the cluster support of the circuit breaker, and the second end portions are configured to receive and electrically mate with the stab terminal of the bus bar. The cluster connector also includes first and second biasing members, each of which is engaged with a respective one of the stacks of plates. The first and second biasing members cooperatively bias the first end portions of the stacks of plates towards one another. The first end portions of the asymmetric plates cooperatively define a channel that is configured to seat therein the pivot of the cluster support. The first end portions further define a slot configured to trap therein a complementary contoured latch projecting from the pivot to thereby lock the cluster connector to the cluster support.

The foregoing summary is not intended to represent each embodiment or every aspect of the present disclosure. Rather, the foregoing summary merely provides an exemplification of some of the novel features and aspects included herein. The above features and advantages, and other features and advantages of the present disclosure, will be readily apparent from the following detailed description of exemplary embodiments and modes for carrying out the present invention when taken in connection with the accompanying drawings and appended claims.

### BRIEF DESCRIPTION OF THE DRAWINGS

FIG. 1 is a perspective-view illustration of a representative circuit breaker assembly electrically coupled to a representative switchgear assembly in accordance with aspects of the present disclosure.

FIG. 2 is a perspective-view illustration of an exemplary circuit breaker cluster support in accordance with aspects of the present disclosure.

FIG. 3 is a perspective-view illustration of an exemplary self-locking cluster connector in accordance with aspects of the present disclosure.

FIG. 4 is an exploded perspective-view illustration of the self-locking cluster connector of FIG. 3.

FIG. 5 is a plan-view illustration of an exemplary cluster connector and an exemplary cluster support, showing the proximal end portions of the cluster fingers of the cluster connector spreading to receive the pivot of the cluster support.

FIG. 6 is another plan-view illustration of the cluster connector and cluster support of FIG. 5, showing the proximal end portions of the cluster fingers contracting to straddle the pivot and to secure the contoured latch within the fingers.

FIG. 7 is another plan-view illustration of the cluster connector and cluster support of FIG. 5, showing the distal end portions of the cluster fingers spreading to receive a stab terminal.

FIG. 8 is an alternative plan-view illustration of the cluster connector and cluster support of FIG. 5, showing the distal end portions of the cluster fingers rotating to receive a stab terminal.

FIG. 9 is a plan-view illustration of two other exemplary cluster connectors and two other exemplary cluster supports in accordance with aspects of the present disclosure.

While the present disclosure is susceptible to various modifications and alternative forms, specific embodiments have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of the invention as defined by the appended claims.

### DETAILED DESCRIPTION

This invention is susceptible of embodiment in many different forms. There are shown in the drawings and will herein be described in detail representative embodiments of the invention with the understanding that the present disclosure is to be considered as an exemplification of the principles of the invention and is not intended to limit the broad aspects of the invention to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise.

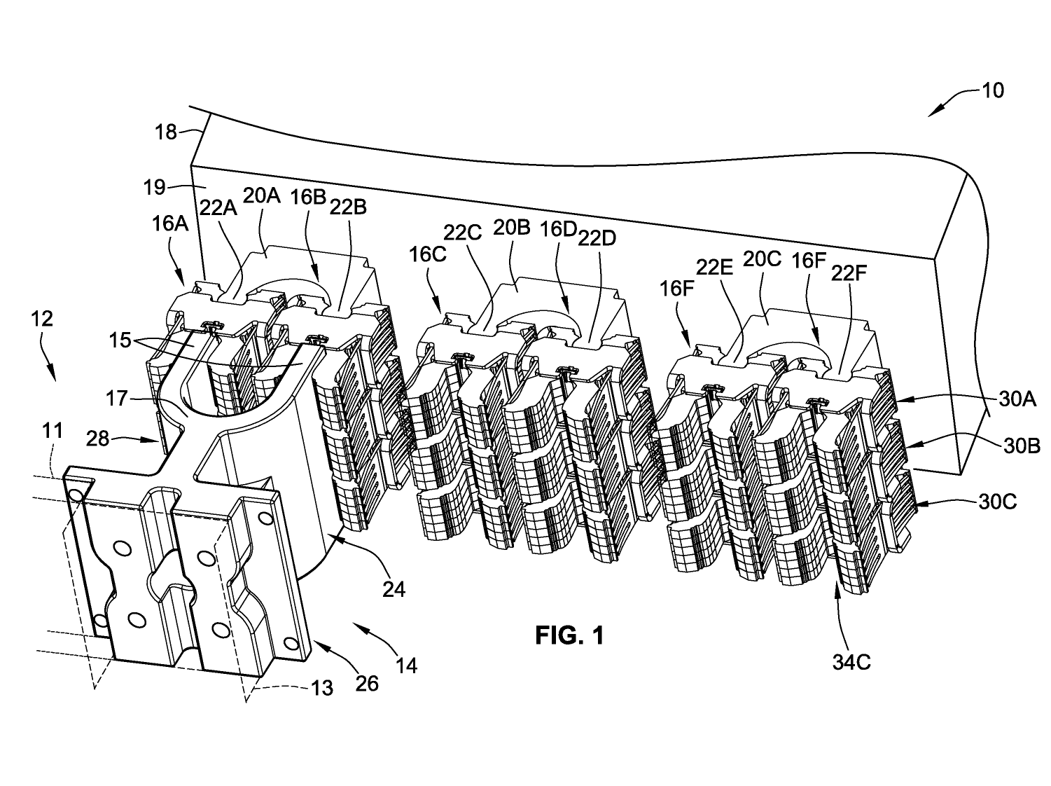

Referring now to the drawings, wherein like reference numbers refer to like components throughout the several views, FIG. 1 is a perspective-view illustration of a representative circuit breaker assembly, designated generally as 10. The circuit breaker assembly 10 may take on a variety of different forms, but it is desirable in at least some embodiments for the circuit breaker 10 to be a “draw-out type” circuit breaker. For some non-limiting examples, a suitable circuit breaker assembly can be based on the exemplary draw-out type circuit breakers disclosed in U.S. Pat. No. 5,036,427, to Thomas J. Krom et al., and U.S. Pat. No. 4,531,174, to Bernard C. Rickmann, both of which are incorporated herein by reference in their respective entireties and for all purposes. In this regard, the circuit breaker assembly 10 can be conventionally mounted for movement into and out of a representative switchgear assembly, which is designated generally at 12 in FIG. 1, for connection to an electrically conductive power bus bar. A representative racking device for racking draw-out type circuit breakers into and out of a switchgear cell is disclosed, for example, in U.S. Pat. No. 5,477,017, to David L. Swindler et al., which is incorporated herein by reference in its entirety and for all purposes. The switchgear assembly 12 can comprise a convention cabinet (also referred to herein as “enclosure” or “housing”), which is generally represented in the drawings by a rigid backmold (illustrated schematically at 11) and a turnable joint coupling (illustrated schematically at 13), which can be electrically connected to a power bus bar (not visible in the view provided). Additional information regarding switchgear assemblies can be found, for example, in U.S. Pat. No. 6,242,702, to Jacob B. Spiegel et al., which is also incorporated herein by reference in its entirety and for all purposes. While the illustrated embodiment is shown as a switchboard apparatus, it should be understood that aspects of the present disclosure could be embodied in other types of electrical apparatuses including, without limitation, motor controllers and other load controllers.

In the illustrated embodiment, the circuit breaker assembly 10 is electrically coupled to the switchgear assembly 12 via one or more electrically conductive power connectors 14, which can be of the turnable joint mount (TJM) connector type. Although only one electrical power connector 14 is shown in FIG. 1, it should be readily understood that the switchgear assembly 12 will typically include a number of similarly oriented power connectors 14—e.g., one connector for each of the circuit breaker cluster supports 20A-C. When properly connected, the circuit breaker 10 can be operable to distribute power from a primary power source, such as a standard utility power source, to a load. The circuit breaker assembly 10 includes, for example, a housing 18 with a rearward facing wall 19. Three substantially identical cluster supports 20A-C are fixed to the rearward facing wall 19 of the circuit breaker housing 18, oriented parallel to one another in a generally vertical orientation. Integrally formed with or otherwise attached to each cluster support 20A-C exemplified in FIG. 1 is a pair of vertically oriented, laterally spaced pivots 22A-F. The pivots 22A-F are elongated rails that project generally orthogonally from the rearward facing wall 19 of the circuit breaker housing 18. For some alternative embodiments, the power connector(s) 14 can be rigidly mounted to the circuit breaker assembly 10 while the pivot(s) 20A-C are rigidly mounted to the backmold 11 of the switchgear assembly 12.

It should be understood that the drawings are not necessarily to scale and are provided purely for explanatory purposes; as such, the individual and relative dimensions and orientations presented herein are not to be considered limiting. To that end, the circuit breaker 10 can include greater or fewer than three cluster supports 20A-C of similar or differing structure to that shown in the drawings. In a similar regard, each cluster support 20A-C can include greater or fewer than two cluster pivots 22A-F of similar or differing structure to that shown in the drawings. Likewise, each pivot 22A-F can be sized to support greater or fewer than three breaker connectors 30A-C (also referred to herein as “cluster connector”).

The power connector 14 comprises three primary segments: a fork-shaped head 24, a base 26, and a yoke 28. In general, the yoke 26 extends between and electrically connects the base 26 to the fork-shaped head 24. The head 24, base 26, and yoke 28 can be integrally formed as a single-piece, monolithic structure, as seen in FIG. 1. It may be desirable in some aspects of this disclosure that the power connector 14 be formed via casting or molding. Optionally, the power connector 14 be formed via extrusion or other known methods, which can include various known machining operations. For some applications, it is desirable that the power connector 14 be fabricated from a highly electrically conductive material, such as copper or aluminum. The fork-shaped head 24 is configured to electrically connect the power connector 14 to the circuit breaker assembly 10 of FIG. 1. For instance, the fork-shaped head 24 comprises two generally flat, blunt-ended prongs (also known as “tines” or “stabs”) 15 that are connected via an intermediate web 17. Each prong 15 is designed to receive thereon and thereby operatively connect to one or more breaker clusters, such as the cluster connectors 30A-C of FIG. 1. The base 26, generally speaking, is configured to mount the power connector 14 to a mounting surface of the switchgear assembly 12, such as the backmold 11, and operatively couple the power connector 14 to an electrical circuit by way of a bus bar through the turnable joint coupling 13. The power connectors 14, singly and in any combination, can take on a variety of different configurations, including numerous shapes and sizes, some of which are disclosed in commonly owned, co-pending U.S. patent application Ser. No. 13/155,974 (corresponding to Pre-grant Patent Publication No. US2012/0314340 A1), which was filed on Jun. 8, 2011, and is incorporated herein by reference in its entirety and for all purposes.

The circuit breaker 10 is electrically coupled to each power connector 14 by one or more columns 16A-F of self-locking “cluster-type” breaker connectors, three of which are designated 30A-C in FIG. 1. In FIG. 1, for example, two columns of cluster connectors 30A-C electrically couple each cluster support 20A-C of the circuit breaker 10 to a power connector 14 of the switchgear assembly 12. Each column 16A-F of the illustrated example includes three substantially identical breaker connectors 30A-C (i.e., 18 total cluster connectors in the illustrated embodiment) that are vertically stacked one on top of the other. Each cluster connector 30A-C has a first (“breaker-side” or “proximal”) end portion, designated generally as 32 in FIG. 3, opposing a second (“bus-side” or “distal”) end portion, designated generally as 34 in FIG. 3. As will be developed in extensive detail hereinbelow, the first end portions 32 are designed to operatively attach to (e.g., seat on and straddle) one of the pivots 22A-F of the cluster supports 20A-C. The second end portions 34, in contrast, are designed to operatively attach to one of the power connectors 14 (e.g., interference-fit and clamp onto a stab 15).

Although shown interfacing with six breaker clusters 30A-C, each power connector 14 can be configured to mate with fewer or greater than six cluster connectors 30A-C, each of which may be similar or different in design to the breaker clusters shown in the drawings. For example, the power connector 14 can be configured to mate with one or more of the cluster connector designs presented in commonly owned U.S. Pat. No. 8,197,289 B1, to Timothy R. Faber et al., which is incorporated herein by reference in its entirety and for all purposes. In the same vein, the cluster connectors disclosed herein can be adapted to incorporate many of the options, features and alternatives disclosed in the aforementioned '289 Patent. For some alternative embodiments, the cluster connectors 30A-C are locked to pivot(s) that are rigidly mounted to the backmold 11 of the switchgear assembly 12,

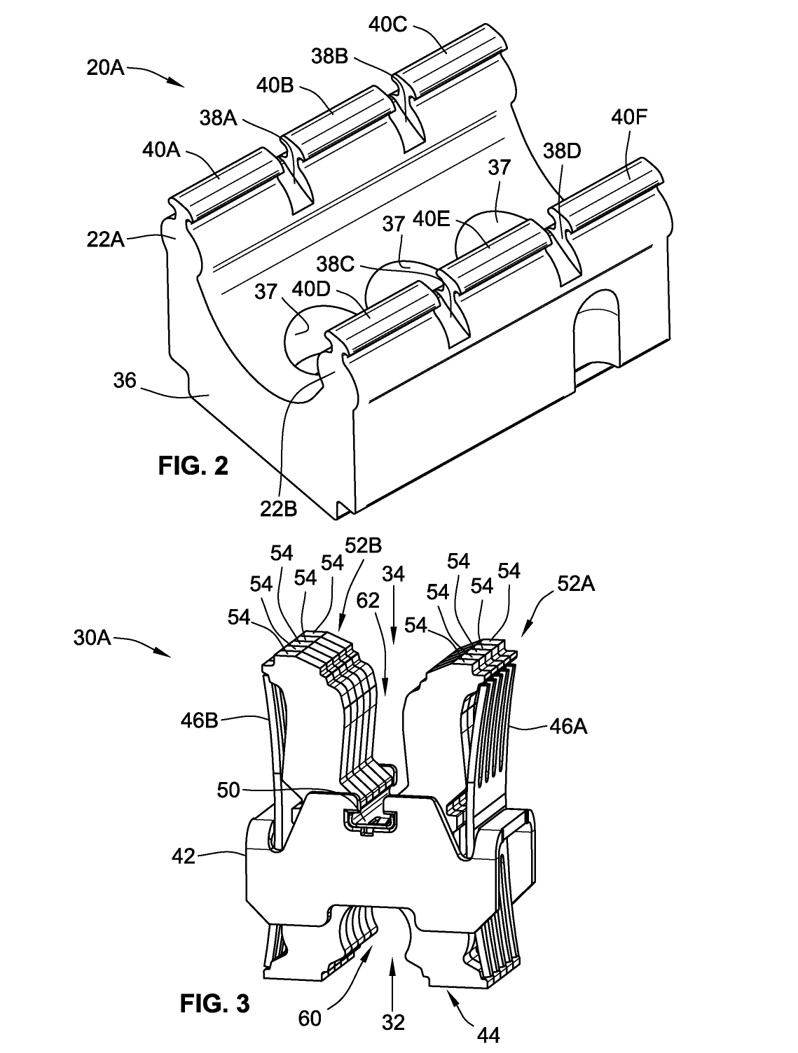

With reference next to FIG. 2, there is shown an example of one of the cluster supports 20A-C from FIG. 1. In general, the electrically conductive cluster supports 20A-C operate as electrical conduits for passing electrical current between the switchgear assembly 12 and the circuit breaker 10. Although not per se required, the cluster supports 20A-C shown in FIG. 1 are structurally identical; as such, for efficiency and conciseness, all three cluster supports 20A-C will be described with reference to the first cluster support 20A. Like the power connector 14 of FIG. 1, the cluster support 20A may be formed as a single-piece, unitary structure (e.g., via casting, molding, extrusion, machining, etc.) from a highly electrically conductive material, such as copper or aluminum. A base 36 of the cluster support 20A is configured to rigidly mount or otherwise electrically couple to a circuit breaker, e.g., via one or more bolt cavities 37 through which bolts or other fasteners may be passed.

One or more pivots 22A-B project from the base 36 of each cluster support 20A. As indicated above, the cluster support 20A of FIGS. 1 and 2 includes two substantially parallel, laterally spaced pivots 22A-B, each of which is an elongated rail. When the support 20A is operatively attached to the circuit breaker 10, the pivots 22A-B project generally orthogonally from the rearward facing wall 19 of the circuit breaker housing 18. As best seen in FIG. 2, each pivot 22A-B has an elongated, generally cylindrical form with one or more longitudinally spaced recesses 38A-D. To ensure proper installation of the cluster connectors 30A-C, each recess 38A-D is configured to receive therein a portion of a cage (or other segment) of one or more of the cluster connectors 30A-C. In so doing, the recesses 38A-D help to ensure that the cluster connectors 30A-C are properly seated and spaced on the pivot 22A-B.

At least one and, in some embodiments, two or more contoured latches 40A-F project from the forward-most portion of each pivot 22A-B (i.e., the portion facing the backmold 11 and power connector 14). In accord with the illustrated example, each contoured latch 40A-F is an elongated T-shaped rail for latching one of the cluster assemblies 30A-C to the pivot 22A-B. According to the embodiment shown in FIG. 2, three coplanar contoured latches 40A-C project from the first pivot 22A, while three other coplanar contoured latches 40D-F project from the second pivot 22B. Latches 40A-F may be structurally identical and, for some embodiments, integrally formed with a corresponding one of the pivots 22A-B. The contoured latches, singly, collectively, or in any combination, may take on other functional shapes that can provide the desired positive-latching function described herein, such as T-shaped, mushroom-shaped, or triangular-shaped projections and rails.

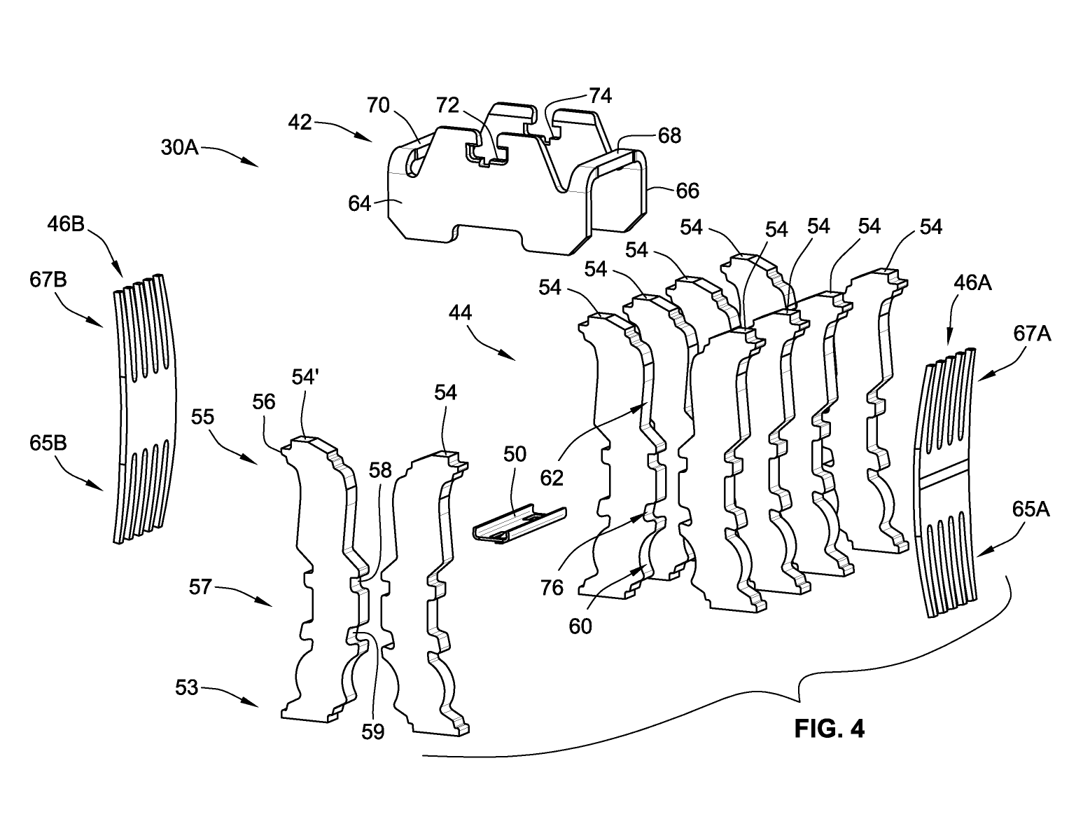

When properly seated on a corresponding cluster support 20A-C and mated with a corresponding power connector 14, the electrically conductive cluster connectors 30A-C operate as electrical conduits for passing electrical current between the circuit breaker 10 and the switchgear assembly 12. FIGS. 3 and 4 illustrate an exemplary cluster connector, indicated generally at 30A, in accordance with aspects of the present disclosure. Although not per se required, the cluster connectors shown in FIG. 1 are structurally identical; as such, for efficiency and conciseness, all of the cluster connectors will be described with reference to the first cluster connector 30A. According to the illustrated embodiment, the cluster connector 30A includes a cage 42, a finger cluster, which is designated generally as 44, one or more dual-fork-shaped leaf springs 46A and 46B, and an elongated, U-shaped spacer 50. The cluster 44 generally includes first and second opposing stacks 52A and 52B, respectively, of electrically conductive, elongated, asymmetric plates 54 (also referred to herein as “fingers”). The plates 54 can be mated in opposing pairs and pivotably mounted to the cage 42, for example, via spacer 50.

In some embodiments, the plates 54 are substantially structurally identical; as such, the plates 54 will be collectively described herein with respect to a single plate 54′ shown on the far-left of FIG. 4. However, in alternate configurations, the plates 54 may be individually or collectively varied in shape and size from that which is shown in the drawings. Each plate 54′ can be a single-piece, unitary structure that is fabricated (e.g., stamped) from an electrically conductive material, such as aluminum or copper. The plate 54′ has a first (“lower” or “proximal”) end portion 53 opposing a second (“upper” or “distal”) end portion 55, the end portions 53, 55 being interconnected by a middle portion 57, which is generally located between the two end portions 53, 55. A tab 56 projects laterally outward from the second end portion 55 such that the tab 56 can be received in and mate with a tool (one of which is shown, for example, in U.S. Pat. No. 8,197,289 B1). The tool applies a compressive force to the second end portions 55 of the opposing pairs of fingers 54, which acts to separate the first end portions 53 such that the cluster connector 30A can be attached to and detached from a pivot 22A-B of the circuit breaker 10. For some configurations, the cluster fingers 54 can be hand squeezed for installation and removal of the cluster assemblies 30A.

In addition, each of the middle portions 57 includes a first notch 58; when mated in opposing pairs, the notches 58 cooperatively define an elongated channel within which is received the spacer 50. The spacer 50, in turn, is attached to the cage 42 as described below to thereby pivotably mount the first and second opposing stacks of plates 52A and 52B to the cage 42. Each of the middle portions 57 also includes a second notch 59; when mated in opposing pairs, these notches 59 cooperatively define an elongated slot within which is received one of the contoured latches 40A-F.

As noted previously, the cluster connector 30A is designed to electrically connect an electrical switch, such as circuit breaker 10 of FIG. 1, to an electrical conductor, such as a power bus bar of switchgear assembly 12 of FIG. 1. The first end portions 53 of the plates 54, for example, are configured to operatively attach to a cluster support 20A-C of the circuit breaker 10, whereas the second “upper” end portions 55 of the plates 54 are configured to operatively attach to the power connector 14. By way of non-limiting example, the first end portions 53 of each mating pair of opposing fingers 54 are shaped to cooperatively define a cylindrically shaped “first” channel (generally designated by reference numeral 60 in FIG. 3) with the same general profile as the cylindrically shaped pivots 22A-F of the circuit breaker cluster supports 20A-C. In so doing, the first end portions 53 of the fingers 54 (and, thus, the first “breaker-side” end portion 32 of the cluster connector 30A) can securely seat on and straddle one of the cluster supports 20A-C of the circuit breaker 10. In a similar regard, the second end portions 55 of each mating pair of opposing fingers 54 are shaped to cooperatively define a polyhedral-shaped “second” channel (generally designated by reference numeral 62 in FIG. 3) with a complementary profile for receiving one of the stabs 15 of the power connector 14. Thus, when the circuit breaker 10 is racked and moved into the switchgear assembly 12, the second end portions 55 of the fingers 54 (and, thus, the second “bus-side” end portion 34 of the cluster connector 30A) press-fit and clamp onto one of the stabs 15 of the power connector 14, as illustrated in FIG. 1.

With continuing reference to FIGS. 3 and 4, the cage 42 of the illustrated connector 30A acts as a functional sleeve or casing, extending generally continuously around the outer perimeter of the cluster 44 and springs 46A-B to thereby maintain the fingers 54 in their respective stacks 52A, 52B. The cage 42 can be a single-piece, unitary structure that is fabricated (e.g. stamped) from a structurally appropriate, non-magnetic material, such as brass or stainless steel. The cage 42 includes first and second opposing, generally flat end walls 64 and 66, respectively, that are attached together via first and second elongated connecting arms 68 and 70, respectively, that extend between and are generally perpendicular to the end walls 64, 66. Both stacks of fingers 52A, 52B nest within the cage 42, as seen in FIG. 3, with a first (“forward-most”) pair of fingers laying generally parallel to and flat against the first end wall 64, and a second (“rearward-most”) pair of fingers laying generally parallel to and flat against the second end wall 66. Each of the end walls 64, 66 includes a respective window 72 and 74. When assembling the connector 24, the first and second stacks 52A, 52B are positioned inside the cage 42 and oriented such that the notches 58 align to cooperatively define a channel, which is then lined up with the windows 72, 74. The spacer 50 is then inserted into one of the windows 72, 74, through the notches 58 between the opposing stacks of fingers 52A and 52B, and to the other window 72, 74. In this manner, the spacer 50 pivotably attaches the fingers 54 to the cage 50 and maintains a space between the stacks of fingers 52A and 52B.

The first and second leaf springs 46A, 46B (also referred to herein as “biasing members”) cooperatively bias the first end portions 53 of the pivotably mounted stacks of plates 52A, 52B laterally inwardly towards one another. By way of example, and not limitation, the first dual-fork-shaped leaf spring 46A is interleaved between the cage 42 and the first stack of fingers 52A, whereas the second dual-fork-shaped leaf spring 46B is interleaved between the cage 42 and the second stack of fingers 52B. A first (“lower”) end portion 65A of the first leaf spring 46A presses against the first end portions 53 of the first stack of fingers 52A, while a second (“upper”) end portion 67A of the first leaf spring 46A presses against the second end portions 55 of the first stack of fingers 52A. The first dual-fork-shaped leaf spring 46A is pinned within the cage 50, bowed inwardly by and pivoting about the inside edge of the first connecting arm 68. In a similar respect, a first (“lower”) end portion 65B of the second leaf spring 46B presses against the first end portions 53 of the second stack of fingers 52B, while a second (“upper”) end portion 67B of the second leaf spring 46B presses against the second end portions 55 of the second stack of fingers 52B. The second dual-fork-shaped leaf spring 46B is pinned within the cage 50, bowed inwardly by and pivoting about the inside edge of the second connecting arm 70. The connecting arms 68, 70 are longitudinally offset with respect to the centers of the leaf springs 46A, 46B and the pivot points (e.g., the spacer 50) of the opposing finger stacks 42A and 42B. Namely, the connecting arms 68, 70 are positioned closer to the first “lower” end portions 65A, 65B of the leaf springs 46A, 46B than the second “upper” end portions 67A, 67B of the leaf springs 46A, 46B. This acts to create a moment arm on the leaf springs 46A, 46B such that the leaf springs 46A, 46B bias the first end portions 53 of the fingers 54 inwardly (e.g., onto a cluster support 20).

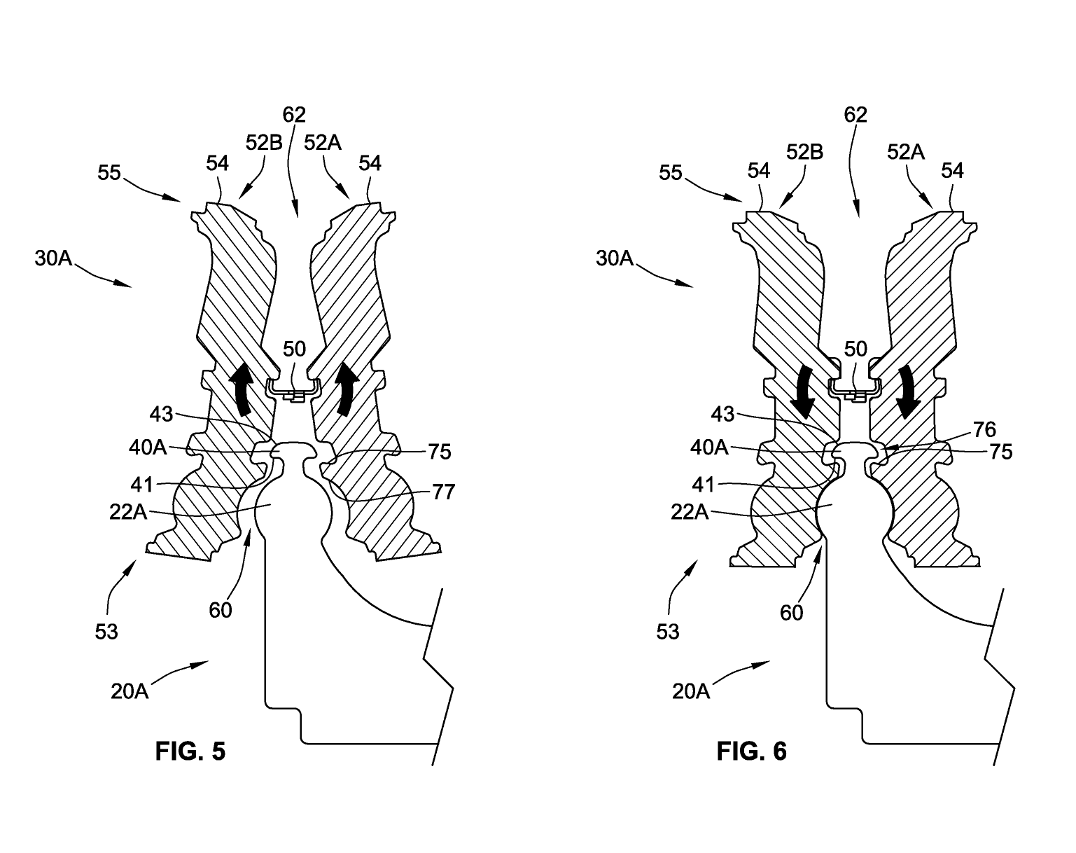

The cluster connector 30A can be self-locking in that it can achieve and maintain a locked position on a pivot without the need for external features, such as retainer pins, retainer clips, anchors, special tools, etc. For example, the cluster connector 30A cooperates with the pivot 22A to provide “fastener grade” retention without using additional fasteners, clamps, or other separate attachment means, thus requiring fewer parts, reducing complexity, and reducing parts and labor costs. By way of example, and not limitation, the lower end portions 53 of the opposing pairs of fingers 54 are shaped to cooperatively define an elongated slot (generally designated by reference numeral 76 in FIGS. 4 and 6) that is configured to receive the contoured latch 40A of the pivot 22A to thereby secure the cluster connector 30A to the cluster support 20A. FIG. 5 illustrates the exemplary cluster connector 30A, showing the distal end portions 55 of the cluster fingers 54 being urged together such that the proximal end portions 53 spread to receive the pivot 22A of the cluster support 20A. FIG. 6 shows the cluster connector 30A and cluster support 20A (which may be collectively referred to herein as “power connection system”) after the fingers 54 have been biased together via the springs 46A-B such that the connector 30A and support 20A are locked together through cooperative operation of the latch 40A and channel 76 of the fingers 54. As indicated above, the contoured latch 40A is an elongated T-shaped rail. Likewise, the complementary slot 76 defined by the proximal end portions 53 of the fingers 54 is an elongated T-shaped slot. When nested inside the slot 76, the fingers 54 prevent the contoured latch 40A from being unintentionally released from the slot 76. In particular, the contoured latch 40A includes a rearward face with a rearward latching surface 41, while the proximal end portions 53 of the fingers 54 each includes a complementary latching surface 75 on the inside of the slot 76. When the fingers 54 are biased together via the leaf springs 46A-B, the complementary latching surfaces 75 of the fingers 54 are configured to abut the rearward latching surface 41 of the contoured latch 40A to thereby prevent the cluster connector 30A from being inadvertently dislodged from the pivot 22A (e.g., when the circuit breaker 10 is being connected to or dis-connected from the switchgear assembly 12).

The power connection system of FIG. 5 can also offer a self-aligning feature to prevent unintentional misalignment of the electrically conductive fingers 54 when securing the cluster connector 30A to the pivot 22A and/or when mating the cluster connector 30A with a stab terminal 15. In one example, the contoured latch 40A includes a forward face with an angled guide surface 43. In addition, each of the proximal end portions 53 of the fingers 54 includes a complementary guide surface 77 located on the inside of the channel 60. When the cluster connector 30A is pressed onto the cluster support 20A, the angled guide surface 43 of the contoured latch 40A presses against the complementary guide surfaces 77 of one or more of the fingers 54. In so doing, the angled guide surface 46 and complementary guide surfaces 77 cooperate to automatically align the fingers 54 when the cluster connector 30A is being seated on the pivot 22A.

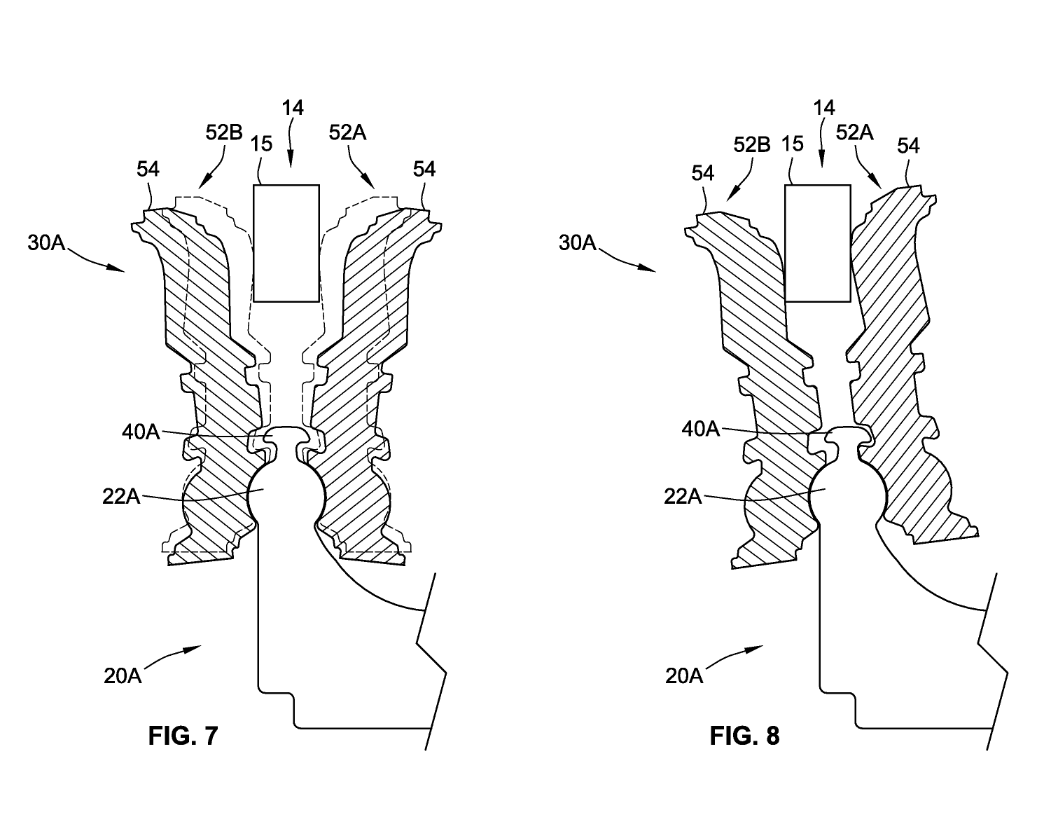

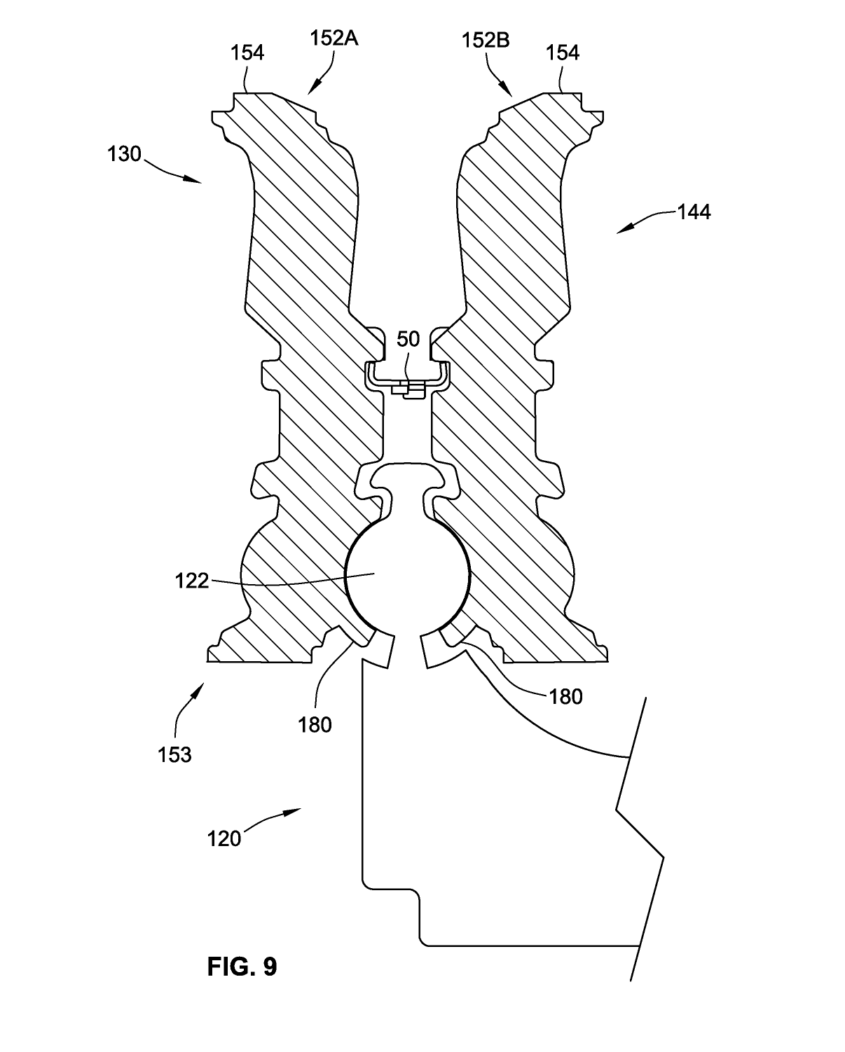

As indicated above, the opposing stacks 52A-B of fingers 54 are pivotably attached to the cage 42 such that urging together the distal end portions 55 of the fingers 54 will pivot the first end portions 53 of the fingers 54 away from one another such that the cluster connector 30A can be seated on or removed from the pivot 22A of the cluster support 20A. For some optional configurations, FIG. 7 shows that the opposing stacks 52A-B of fingers 54 can be pivotably mounted such that forcing apart the second end portions 55 of the fingers 54 will move the first end portions 53 of the fingers 54 towards one another. By this means, the channel 62 can more easily receive therein and the second end portions 55 of the fingers 54 can more easily mate with and straddle the stab terminal 15 of the electrical power connector 14. In some optional configurations, the elongated slot 76 defined by the first end portions 53 has a first width and the contoured latch 40A has a second width that is smaller than the first width such that the cluster connector 40A can rotate on the pivot 22A when coupled to the cluster support 20A, as seen in FIG. 8. This central pivot permits greater rotational self-alignment of the cluster connector 30A on the support 20A.

Turning next to FIG. 9, wherein like reference numerals refer to like components from FIGS. 3 and 4, another exemplary cluster connector, indicated generally at 130, is presented in accordance with aspects of the present disclosure. Unless otherwise explicitly disclaimed, the cluster connector 130 of FIG. 9 can include any of the options, features and alternatives described herein with respect to the cluster connector 30A of FIGS. 3 and 4. For instance, the power connector 130 of FIG. 9 includes a cage (not shown in FIG. 9), such as cage 42, a finger cluster, which is designated generally as 144, one or more biasing members (not shown in FIG. 9), such as the dual-fork-shaped leaf springs 46A and 46B, and an elongated, U-shaped spacer 50. In the embodiment illustrated in FIG. 9, the cage, biasing members, and spacer can be structurally and functionally identical to those shown in FIGS. 3 and 4. Therefore, for brevity and conciseness, these components will not be described again in detail. In alternative configurations, however, the cage, biasing members, and spacer of the cluster connector 130 of FIG. 9 can be individually or collectively varied in structure and/or function from those shown in FIGS. 3 and 4.

The cluster 44 generally includes first and second opposing stacks 152A and 152B, respectively, of electrically conductive, elongated, asymmetric plates or “fingers” 154. The plates 154 can be mated in opposing pairs and pivotably mounted to a cage, for example, via the spacer 150. Each plate 154 can be a single-piece, unitary structure that is fabricated (e.g., stamped) from an electrically conductive material, such as aluminum or copper. Unlike the cluster connector 30A described above, the fingers 154 of the cluster connector 130 include retention hooks 180 that provide additional contact surface area between the first end portions 153 of the fingers 154 and the pivot 122 of the cluster support 120. The retention hooks 180 also provide additional securing means for locking the cluster 144 to the pivot 122 and thereby preventing the unintentional dislodging of the cluster connector 130 from the cluster support 120.

While particular aspects, embodiments, and applications of the present disclosure have been illustrated and described, it is to be understood that the present disclosure is not limited to the precise construction and compositions disclosed herein and that various modifications, changes, and variations may be apparent from the foregoing descriptions without departing from the spirit and scope of the invention as defined in the appended claims. Lastly, all of the patent and non-patent literature discussed above is incorporated herein by reference.

What is claimed is:

1. A power connection system for electrically connecting a circuit breaker to an electrically conductive bus bar, the power connection system comprising:
an electrically conductive cluster support configured to attach to one of the circuit breaker and the bus bar, the cluster support having a base, a pivot projecting from the base, and a contoured latch projecting from the pivot; and
an electrically conductive cluster connector configured to electrically couple the circuit breaker to the bus bar, the cluster connector including:
a cage;
opposing pairs of electrically conductive fingers pivotably attached to the cage, each finger having opposing proximal and distal end portions, the proximal end portions of the opposing pairs of fingers being configured to straddle the pivot of the cluster support; and
first and second spring members biasing the proximal end portions of the opposing pairs of fingers toward one another,
wherein the proximal end portions of the fingers cooperatively define a channel configured to receive the pivot, and further define a slot configured to receive the contoured latch of the pivot to thereby secure the cluster connector to the cluster support.

2. The power connection system of claim 1, wherein the contoured latch includes a rearward face with a rearward latching surface, and the proximal end portions of the fingers each includes a complementary latching surface on the inside of the slot, the complementary latching surfaces of the fingers being configured to abut the rearward latching surface of the contoured latch to thereby aid in preventing the cluster connector from being dislodged from the pivot.

3. The power connection system of claim 1, wherein the contoured latch includes a forward face with an angled guide surface, and the proximal end portions of the fingers each includes a complementary guide surface, the angled guide surface of the contoured latch pressing against the complementary guide surfaces to automatically align the fingers when the cluster connector is being seated on the pivot.

4. The power connection system of claim 1, wherein the slot has a first width and the contoured latch has a second width smaller than the first width such that the cluster connector can rotate on the pivot when coupled to the cluster support.

5. The power connection system of claim 1, wherein the contoured latch is an elongated T-shaped rail.

6. The power connection system of claim 5, wherein the slot defined by the proximal end portions of the fingers is an elongated T-shaped slot.

7. The power connection system of claim 1, wherein the pivot is an elongated and cylindrical form.

8. The power connection system of claim 7, wherein the channel defined by the proximal end portions of the fingers is an elongated and cylindrical channel.

9. The power connection system of claim 1, wherein the opposing pairs of fingers are pivotably attached to the cage such that urging together the distal end portions of the fingers will pivot the proximal end portions of the fingers away from one another such that the cluster connector can be seated on the pivot of the cluster support.

10. The power connection system of claim 1, wherein the cluster support, including the base, the pivot, and the contoured latch, are formed is a single-piece, unitary structure.

11. The power connection system of claim 1, further comprising an electrical power connector with a stab terminal, the distal end portions of the fingers being configured to straddle the stab terminal of the electrical power connector.

12. The power connection system of claim 1, wherein the cluster connector further comprises a spacer attached to the cage and positioned between the opposing pairs of fingers, the fingers being pivotably mounted to the cage via the spacer.

13. The power connection system of claim 1, wherein the cage includes first and second end walls attached together via first and second connecting arms extending between the first and second end walls, the end walls and connecting arms of the cage cooperatively circumscribing the fingers and the spring members.

14. A switchgear assembly for electrically coupling a circuit breaker to an electrically conductive power bus bar, the switch gear assembly comprising:
a housing configured to receive therein the circuit breaker;
a backmold mounted at a distal end of the housing;
an electrical power connector including a stab terminal projecting from a base, the base being mounted to the backmold and configured to electrically connect to the bus bar;
an electrically conductive cluster support configured to attach to the circuit breaker, the cluster support having a base, a pivot projecting from the base, and a contoured latch projecting from the pivot; and
an electrically conductive cluster connector including a cage, a cluster, and first and second spring members, the cluster including opposing pairs of electrically conductive fingers pivotably attached to the cage, each finger having opposing proximal and distal end portions, the proximal end portions of the fingers being configured to straddle the pivot of the cluster support, the distal end portions being configured to electrically mate with the stab terminal of the electrical power connector, and the spring members biasing the proximal end portions of the opposing pairs of fingers toward one another,
wherein the proximal end portions of the cluster fingers cooperatively define a channel configured to receive the pivot, and further define a slot configured to receive the contoured latch of the pivot to thereby secure the cluster connector to the cluster support.

15. The switchgear assembly of claim 14, wherein the contoured latch includes a rearward face with a rearward latching surface, and the proximal end portions of the fingers each includes a complementary latching surface on the inside of the slot, the rearward latching surface of the contoured latch abutting the complementary latching surfaces of the fingers to thereby prevent the cluster connector from being dislodged from the pivot.

16. The switchgear assembly of claim 14, wherein the contoured latch includes a forward face with an angled guide surface, and the proximal end portions of the fingers each includes a complementary guide surface, the angled guide surface of the contoured latch pressing against the complementary guide surfaces of the fingers to automatically align the fingers when the cluster connector is being seated on the pivot.

17. The switchgear assembly of claim 14, wherein the slot has a first width and the contoured latch has a second width smaller than the first width such that the cluster connector can rotate on the pivot when the cluster connector is coupled to the cluster support.

18. The switchgear assembly of claim 14, wherein the contoured latch is an elongated T-shaped rail, and the slot defined by the proximal end portions of the fingers is an elongated T-shaped slot.

19. The switchgear assembly of claim 14, wherein the pivot is an elongated and cylindrical form, and the channel defined by the proximal end portions of the fingers is an elongated and cylindrical channel.

20. A self-locking cluster connector for connecting a circuit breaker to an electrically conductive bus bar in an electrical assembly, the electrical assembly having an electrical power connector with a stab terminal, and a cluster support with a pivot projecting from a base, the cluster connector comprising:
a cage;
first and second opposing stacks of electrically conductive asymmetric plates disposed inside of and pivotably attached to the cage, each plate having opposing first and second end portions, the first end portions of the stacks of plates being configured to receive and attach to the cluster support of the circuit breaker, and the second end portions of the stacks of plates being configured to receive and electrically mate with the stab terminal of the bus bar; and
first and second biasing members each engaged with a respective one of the stacks of plates, the first and second biasing members cooperatively biasing the first end portions of the stacks of plates towards one another;
wherein the first end portions of the asymmetric plates cooperatively define a channel configured to seat therein the pivot of the cluster support, and further define a slot configured to trap therein a complementary contoured latch projecting from the pivot to thereby lock the cluster connector to the cluster support.
